(19) United States
(12) Patent Application Publication
(10) Pub. No.: US 2024/0102657 A1
(43) Pub. Date: Mar. 28, 2024

(54) SYSTEM AND METHOD FOR USING AMMONIA AS A FUEL SOURCE FOR ENGINES

(71) Applicant: University of Central Florida Research Foundation, Inc., Orlando, FL (US)

(72) Inventors: Jayanta Kapat, Oviedo, FL (US); Richard Blair, Oviedo, FL (US); Marcel Otto, Orlando, FL (US); Erik Fernandez, Oviedo, FL (US)

(21) Appl. No.: 18/372,646

(22) Filed: Sep. 25, 2023

Related U.S. Application Data
(60) Provisional application No. 63/409,609, filed on Sep. 23, 2022.
(60) Provisional application No. 63/537,438, filed on Sep. 8, 2023.

(51) Int. Cl. F23R 3/36; B63H 21/16; B64D 27/12; B64D 37/04; B64D 37/34; F23R 3/00

(52) U.S. Cl. CPC F23R 3/36; B63H 21/16; B64D 27/12; B64D 37/04; B64D 37/34; F23R 3/002

(57) ABSTRACT

A power system for an engine that can be used in an aircraft, a marine vessel or a land vehicle has a storage tank containing ammonia. An engine supported on the vehicle is configured to operate using hydrogen gas as fuel. A cracking device in or adjacent the engine receives heat from operation of the engine, e.g., from a compressor or a combustion chamber, and also receives ammonia from the storage tank, and it uses the heat from the engine to dissociate the ammonia to produce hydrogen gas. The cracking device supplies the hydrogen gas to the engine, which has a combustor in which combustion of the hydrogen gas takes place. The energy from the combustion drives the engine so as to provide mechanical energy.

### RELATED APPLICATIONS

This application claims the benefit of U.S. provisional application 63/409,609 filed on Sep. 23, 2022, and U.S. provisional application 63/537,438 filed on Sep. 8, 2023.

This invention was made with government support under NASA Cooperative Agreement No. 80NSSC22M0067 (NASA ULI). The government has certain rights in the invention.

### FIELD OF THE INVENTION

This invention relates to engines, and more particularly to systems and methods for powering engines using ammonia as a source of fuel, and most particularly to using ammonia as a source of hydrogen fuel used by engines, especially aircraft, marine vessel, and other vehicle engines or stationary gas turbines for power generation.

### BACKGROUND OF THE INVENTION

Engines are used to produce mechanical energy that may be used to drive vehicles such as aircraft, ships, and locomotives, or to drive a generator for electrical power generation, relying on combustion of a fuel that is frequently and commonly hydrocarbon or fossil fuel.

At the same time, there is worldwide concern that the levels of CO₂ in the atmosphere are producing climate change that will be potentially catastrophic, and that combustion of carbon-containing fuels contributes to the problem. There is a consequent desire in many quarters to reduce atmospheric concentration of CO₂ by reducing human production of CO₂ by carbon-based fuel usage that releases CO₂ into the atmosphere, a large sector of which is transportation.

One area of particular consideration is aircraft transport. There are more than 5,400 airplanes in the air during peak hours and more than 45,000 daily flights in the U.S., totaling more than 16 million flights per year in pre-pandemic times based on FAA data. According to the U.S. Department of Transportation, the annual transportation of over 1 billion passengers generates more than 10.8 million jobs and constitutes 5.2% of the U.S. GDP.

Currently, aviation accounts for 2.5% of the global CO₂ emissions, but, given increased globalization and the interconnected lifestyle of people worldwide together with the ongoing development of many countries, aviation's share of global CO₂ emissions is expected to rise to 3.5%. That rise would account for roughly 1 billion metric tons of CO₂ per year despite the improved fuel efficiency of newer aircraft.

This growth in aviation CO₂ emissions has fueled the industry's desire to decarbonize as soon as possible. In 2009, the aviation industry agreed to ambitious carbon reduction goals that included stabilizing emissions from 2020 onwards with carbon-neutral growth, and reducing emissions to half of 2005 levels by 2050. Meeting those goals without substantially leaning on offsets will require development of alternative non-carbon based fuels.

Turbofan engines and turbine-based auxiliary power units (APU) are the two major aircraft systems that generate emissions due to their reliance on hydrocarbon fuel, i.e., fossil fuel-based Jet-A fuel. Accordingly, decarbonization of aircraft focuses on the use of carbon-neutral hydrocarbon fuels like drop-in biofuels or sustainable aviation fuels (SAF), or on replacement of the fossil fuel-based Jet-A with other energy carriers such as hydrogen or batteries.

Drop-in biofuels are a near-term way to reduce carbon emissions because they can be incorporated into a global aircraft fleet without requiring major aircraft or infrastructure changes, but the scaling up of manufacturing capability to provide cost-competitive drop-in jet fuels for the global fleet has presented substantial difficulties.

The other alternatives to hydrocarbon-based fuels are batteries and hydrogen. While both electrical and chemical storage can potentially be used in aviation to provide propulsive power, the required thrust-to-weight ratios limit the usage of electrical batteries for small aircraft and short-duration flights.

Hydrogen, sometimes called e-H₂ when obtained by electrolyzing water, therefore appears to be the only e-fuel that will work. Hydrogen has an unmatched gravimetric energy density (LHV) of 120 MJ/kg, which is much higher than 46 MJ/kg for kerosene and makes it a seemingly attractive fuel to burn.

However, hydrogen storage comes with additional complexities, and its volumetric energy density of 8.5 GJ/m3 is far lower than 38 GJ/m3 for kerosene. Owing to its low volumetric energy density, hydrogen needs to be stored as a cryogenic liquid at 20 K in a well-insulated tank or as a gas at very high pressure (700 bar) in a heavy pressure vessel. Either of these hydrogen storage alternatives comes with complexities that are challenging for the commercial air transportation sector. In addition, the smaller molecular size of hydrogen and its wide range of auto-ignition and flammability lead to higher leakage potential and safety risks. Many countries in developing or under-developed parts of the world do not have the infrastructure for safe and reliable hydrogen storage and fueling, which is a serious concern for the safety-conscious aviation industry. Difficulty in the safe and easy handling of hydrogen has limited its widespread usage outside of the space and chemical industries, after decades of efforts, and that raises doubts about the feasibility and practicality of a global infrastructure and supply chain for refueling airplanes worldwide with liquid hydrogen. Also, cryogenic storage leads to thermal shock during refueling, posing increased fatigue failure risks.

Beyond those concerns, although hydrogen combustion does not produce CO₂, the higher flame temperatures in hydrogen combustion also raise concerns about higher NOₓ emissions and higher amounts of water vapor in the exhaust that can lead to increased contrails.

Essentially, hydrogen is touted as the energy carrier of the future as it burns without carbon emissions and can be easily created from water. However, a main challenge associated with hydrogen is its storage. Either heavy compressed air cylinders at 700 bars have to be used or a cryogenic liquid at 20 degrees K. Both of those approaches appear unfeasible in the context of aviation, or other applications where weight or space constraints are of concern.

Other areas of transportation also may be decarbonized to reduce CO₂ emissions. For example, it may be desirable to reduce CO₂ emissions by decarbonizing gas turbine engines in marine vessels used to transport goods or passengers across oceans. Similarly, decarbonizing of turbine or internal combustion engines used for transport on land of goods or people, such as by locomotives in trains, or by other vehicles, may be desirable, as is decarbonization of stationary engines burning fuel to generate electricity However, in all these sectors, similar issues to those described above arise with respect to decarbonizing of those engines.

### SUMMARY OF THE INVENTION

It is therefore an object of the invention to reduce CO₂ emissions in vehicles by providing a system for powering vehicle engines that relies on the combustion of hydrogen or blends of hydrogen that avoids the above-described storage problems.

It is also an object of the invention to provide a system for powering an engine by combustion of hydrogen that reduces NOₓ emissions.

These objectives are accomplished in the invention by using liquid ammonia (NH₃) as a carrier for hydrogen fuel.

In contrast to hydrogen, ammonia does not burn well. However, ammonia is an excellent H₂ -carrier that can be catalytically cracked to provide H₂ gas before combustion, and that can significantly reduce all forms of emissions. Also, ammonia is inherently safer to handle than liquid hydrogen, and does not require cryogenic liquefaction or high-pressure storage like liquid H₂. Ammonia is a denser liquid and is liquid at much higher temperatures. Especially in the context of aviation, no cooling is required at cruising altitudes.

According to an aspect of the invention, ammonia is used as a carrier of electricity-derived, green hydrogen for aviation, with near-zero emissions. Ammonia is used as both a carrier of hydrogen as fuel, and also to provide cooling for compressor intercooling and cooled cooling air for NOₓ elimination and condensation of water vapor in the exhaust to reduce contrail formation.

Ammonia remains in a liquid state over a much wider temperature range than hydrogen, which enhances safety and reduces airport integration hurdles, and ammonia already has a robust and mature supply chain relative to H₂. Relevant property comparisons are listed in Table 1. Thus, while e-H₂ may be the theoretically best fuel to burn in decarbonized aviation, ammonia may be the best means to carry that hydrogen. In addition, there are significant advantages of ammonia over kerosene and hydrogen, in that ammonia offers superior endothermic fuel characteristics over kerosene because it is stored as a liquid at −33° C., it absorbs significant energy when releasing H₂, and it does not form coke.

TABLE 1
COMPARISON OF AMMONIA WITH KEROSENE,
HYDROGEN, AND METHANOL DATA

| Properties | Units | Kerosene | Hydrogen | | Methanol | Ammonia |
|---|---|---|---|---|---|---|
| Stored as | — | Liquid | Gas | Liquid | Liquid | Liquid |
| Temperature | ° C. | Ambient | Ambient | −252.9 | Ambient | −33 (or 25) |
| Pressure | MPa | | 69 | Ambient | | 0.1 (or 0.99) |
| Density | kg/m³ | 840 | 39 | 70.8 | 792 | 600 |
| Explosive | % vol | 0.7 to 5 | 4 to 75 | 4 to 75 | 6.7 to 36 | 15 to 28 |
| Limit | | | | | | |
| LHV | MJ/kg | 43 | 120 | 120 | 20.1 | 18.6 |
| | MJ/L | 35 | 4.5 | 8.49 | 15.8 | 12.7 |
| H2 Content | wt % | N/A | 100 | 100 | 12.5 | 17.8 |
| | kg-H2/m³ | N/A | 42.2 | 70.8 | 99 | 121 |
| Hydrogen | | N/A | Pressure | Evaporation | Catalytic Decomp @ Temp | |
| Release | | | Release | | >200° C. | >300° C. |
| Energy to | kJ/mol-H2 | N/A | — | 0.907 | 16.3 | 30.6 |
| Extract H2(g) | | | | | | |

Interestingly, liquid ammonia carries more hydrogen per unit volume than liquid hydrogen itself, thus providing benefits for storage, for example, within the wings of an aircraft.

According to an aspect of the invention, a power system for a vehicle, comprises a storage tank containing ammonia. An engine supported on the vehicle is configured to operate using hydrogen gas or blends of ammonia and hydrogen as fuel. A conversion device receives ammonia from the storage tank and heat from the engine, and it uses the heat from the engine to dissociate the ammonia to produce hydrogen gas, nitrogen gas, and uncracked ammonia gas. The conversion device supplies the hydrogen gas mix to the engine wherein combustion of the hydrogen gas mix takes place, producing energy that drives the engine so as to generate thrust or move the vehicle, or drives a generator for conversion to electricity and the subsequent powering of an electric motor for moving the vehicle.

According to another aspect of the invention, an aircraft has a storage tank holding ammonia (NH₃) in liquid form in its wing or fuselage and an engine, e.g., a turbofan engine adapted to run on hydrogen gas as fuel, connected with the storage tank. The ammonia is transmitted from the tank to a cracking module that exposes the ammonia to heat, preferably derived from operation of the engine, in the presence of a catalyst, as will be described further below. The cracking module causes the ammonia (NH₃) to dissociate into N₂ and H₂ by the endothermic catalyzed reaction:

2NH₃+heat→N₂+3H₂

According to one embodiment of the invention, the resulting gas mixture of H₂, N₂, and some amount of surviving NH₃, which constitutes less than 10% of the gas mixture, is optionally carried to a separation membrane unit that has a selectively permeable mesh that permits passage of H₂ but not N₂ or NH₃. The separation membrane unit outputs two separate gas streams, one H₂ and the other a mixture of H₂, N₂, NH₃. The H₂ is transmitted to a combustor of the engine where it is combusted with air from the environment, resulting in a combustion product, which is essentially water. The combustion of the hydrogen drives one or more turbines of the engine as is well-known to those of skill in the art, resulting in thrust that propels the aircraft.

According to another embodiment, the cracking module receives the NH₃ and cracks only a portion of the NH₃ into H₂, yielding a mixture of NH₃ and H₂ which is 30% to 70% H₂ and 30% to 70% NH₃. That mixture is supplied to the engine of the vehicle without separation, and the lesser percentage of H₂ in the blend makes the combustion compared to pure NH₃ or H₂ combustion more manageable in the combustor, and reduces NOₓ created during combustion.

The engine preferably includes a low pressure compressor (LPC) that compresses air from outside the engine followed by a high pressure compressor (HPC) that further compresses that air to be used for combustion. The compression steps increase the temperature of the air in addition to its pressure, and that heat is preferably used in the system of the invention to derive H₂ from NH₃.

The heated air from the LPC is used to vaporize liquid NH₃ to produce gaseous NH₃ that flows through the cracking module so as to contact surfaces of catalyst material. That air then flows to the HPC where it is further compressed and heated. Removing heat from the air as it is compressed is referred to as compressor intercooling, and compressor intercooling has the benefit of reduced compressor work, which increases the core efficiency of the engine.

The heated air from the HPC is used for combustion, but a portion of that high-pressure air is a separate stream of cooling air for cooling the turbines of the engine. That cooling air is first directed to the cracking module where it is cooled by releasing heat that heats the catalyst surfaces of the cracking module. That heat provides the endothermic energy that drives the dissociation reaction of the ammonia into N₂ and H₂. The cooler cooling air then leaves the cracking module and is directed to the turbine to cool it. Cooler cooling air has the potential to increase the cooling efficiency in the turbine airfoils. Better cooling efficiency permits for improved core efficiency through either reduced coolant mass flow rate or higher turbine inlet temperatures.

The H₂, N₂, NH₃ gas mixture from the separation membrane unit contains NH₃ in a concentration that may be less than 10% of the mixture, which is the part of the ammonia that passes through the cracking module but is not dissociated, for whatever reason. The H₂, N₂, NH₃ mixture or a portion of it may be mixed with air drawn in to the LPC where it is compressed with the ambient air and transmitted with that compressed air to the combustor and is combusted with the pure H₂ gas stream, where the presence of the trace amount of NH₃ reduces the formation of NOₓ in the combustion products.

The combustion of the H₂ in the combustor produces heat, and alternatively to, or parallel with, using heat from the compressor, the combustor may be configured to use some of that heat from combustion to crack the NH₃, by incorporating the cracking unit in or adjacent the combustor wall.

It is advantageous to also derive energy from the heat of the exhaust gases. For that purpose, the exhaust gas from the turbines of the engine is exposed to a heat exchanger that extracts heat that would otherwise be wasted, and a supercritical CO₂ system uses a Rankin cycle to extract the heat and converts it to electrical power for use in the aircraft.

In addition, the exhaust is acted upon to reduce NOₓ emissions by a Selective Catalytic Reduction (SCR) system in which ammonia products are injected into the exhaust gas stream and reduce NOₓ to N₂ and H₂O. This process is enhanced by a catalytic surface.

Because ammonia is stored as a fuel in systems of the invention, parts of the stored ammonia fuel can be used for this purpose. That ammonia is evaporated from liquid to gas for this purpose, and the heat for this process comes from condensing the water in the exhaust, which reduces contrail emissions.

The use of ammonia as the hydrogen carrier offers multiple benefits, as will be seen from this disclosure, beyond the desirable use of NH₃ for hydrogen generation. It is also beneficial for intercooling between the low and high pressure compressors, for cooling of air used for turbine cooling, for elimination of NOₓ from the exhaust, and for condensing water from the core exhaust to limit contrail formation. These features are enabled by the non-coking properties of NH₃ (in contrast to Jet A or SAF), the ability of NH₃ to reduce NOₓ to N₂ in the presence of a selective catalyst (again, as opposed to both Jet A and H₂), and its significantly lower explosion potential (as opposed to H₂).

According to another aspect of the invention, cracking ammonia is performed within the combustion liner, which reduces the coolant requirement of the system, improving performance and durability, while providing high levels of heat at elevated temperatures for cracking.

Engines used in marine transport, i.e., ships on water, or various land-based transport systems, especially locomotives or large cargo vehicles, as well as gas turbine engines used in stationary power generation, and even internal-combustion reciprocating-piston engines, can also benefit from using ammonia as the source for H₂ gas burned in those engines. The general principle shared by these engines is that ammonia is supplied to a cracking unit that receives heat from either a compressor that compresses intake air to the engine, creating heat, or from the combustor portion of the engine itself so as to use the heat from compression or combustion to produce the cracking of the NH₃ to form H₂ that is subsequently burned in the engine.

Even in ground transport, use of ammonia presents fewer problems in transporting fuel than does H₂ gas, as was set out previously, and ammonia can be the form in which hydrogen is moved in bulk. This means that pipelines can pump ammonia instead of hydrogen, and ships can transport liquefied ammonia over oceans (similarly to LNG) instead of hydrogen. Ammonia can be stored on bases or depots instead of H₂, so that NH₃ is readily available as a fuel and no external cracking prior to use is required.

Other objects and advantages of the invention will become apparent from this specification.

### BRIEF DESCRIPTION OF the Drawings

FIG. 1 is a schematic illustrating the general operation of a system according to the invention using NH₃ to provide H₂ as fuel to an engine.

FIG. 2 shows an aircraft with an ammonia-based fuel system according to the invention.

FIG. 3 is a diagram of the overall structure of a turbofan aircraft engine that can be adapted for use in a system according to the invention.

FIG. 4 is a functional diagram of the operation of the system.

FIG. 5 is a T-s diagram of the engine operating in ground mode.

FIG. 6 is a schematic diagram of an aircraft engine modified to incorporate the ammonia-based fuel system of the invention.

FIG. 7 is cross-sectional diagram through the aircraft engine of FIG. 6.

FIG. 8 is a diagram of the parameters of the heat exchanger used to heat liquid ammonia in the system to convert it to gaseous ammonia.

FIG. 9 is a diagram of a cracking module and a separation membrane unit in a system as shown in FIG. 5.

FIG. 10 is a cross-sectional view through an embodiment of the cracking module.

FIG. 11 is a diagram showing a system in which the cracking module is integrated into the combustor of the engine.

FIG. 12 is a cross-sectional view through the centerline of a combustor showing the channels of cracking unit tubes embedded in the wall of a combustor liner.

FIG. 13 is a cross-sectional view of the apparatus of FIG. 11 through line A-A of FIG. 12.

FIG. 14 is a view as in FIG. 12 of an alternate design of cracking tubes on a container liner.

FIG. 15 is a view as in FIG. 12 of another alternate design of cracking tubes on an inner surface of a container liner.

FIG. 16 is a view as in FIG. 12 of still another alternate design with axially extending cracking tubes in a wall of the container liner.

FIG. 17 is a partially cut-away diagram showing another alternate design of cracking tubes in a container liner.

FIG. 18 is a cross-sectional view along the centerline of a reciprocating piston engine with circumferential cracking tubes, such as those shown in FIG. 12, in the cylinder wall.

FIG. 19 is a graph of the pressure and temperature of the atmosphere encountered at varying altitudes.

### DETAILED DESCRIPTION

A variety of vehicles that are powered by combustion of fuel may rely on combustion of H₂, and engines for those vehicles may advantageously make use of a system supplying H₂ fuel derived from ammonia.

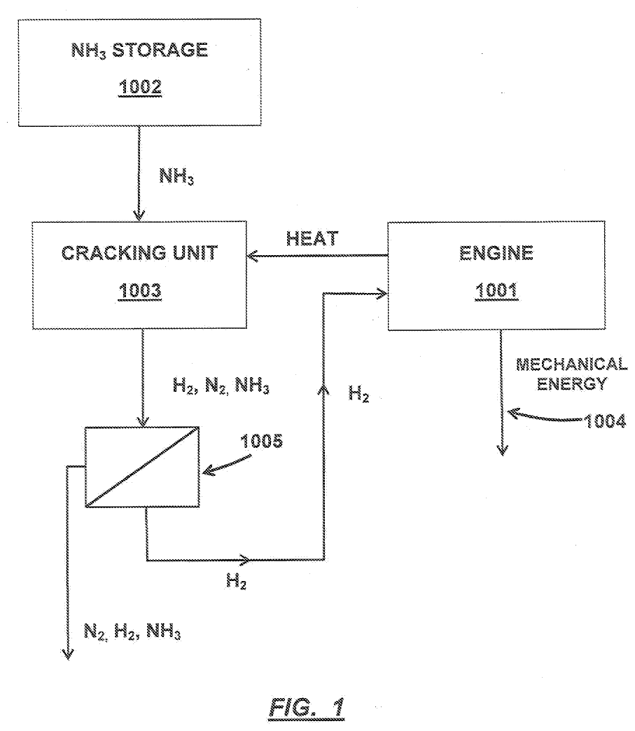

Referring to FIG. 1, the general operation of an engine according to the invention is shown schematically. A vehicle using the system has an engine 1001 and an ammonia (NH₃) storage supply 1002 that stores ammonia as a source of fuel for engine 1001. A cracking unit 1003 is connected with the ammonia storage 1002 and receives NH₃ from it. The cracking unit 1003 contains passages with catalyst in them through which the NH₃ flows. The cracking unit 1003 also receives heat from the engine 1001 during operation, and that heat is applied to cause the NH₃ to be cracked at least partly into a mix of N₂ and H₂, as well as some un-cracked NH₃, as has been described. That mix is transmitted to a separating unit 1005, which has a selectively permeable membrane that permits H₂ to flow through it, and blocks passage of N₂ and NH₃. The result is a gas fraction that is mostly or all H₂, and a remnant fraction that contains the N₂ and NH₃ from the cracking unit 1003, with some H₂ that for whatever reason does not pass through the membrane. The H₂ fraction is supplied from the cracking unit 1003 to the engine 1001, in which it undergoes combustion, creating heat and releasing energy generally indicated at 1004, which may be the exhaust of a jet engine or a rotating drive shaft of a turbine or other engine design.

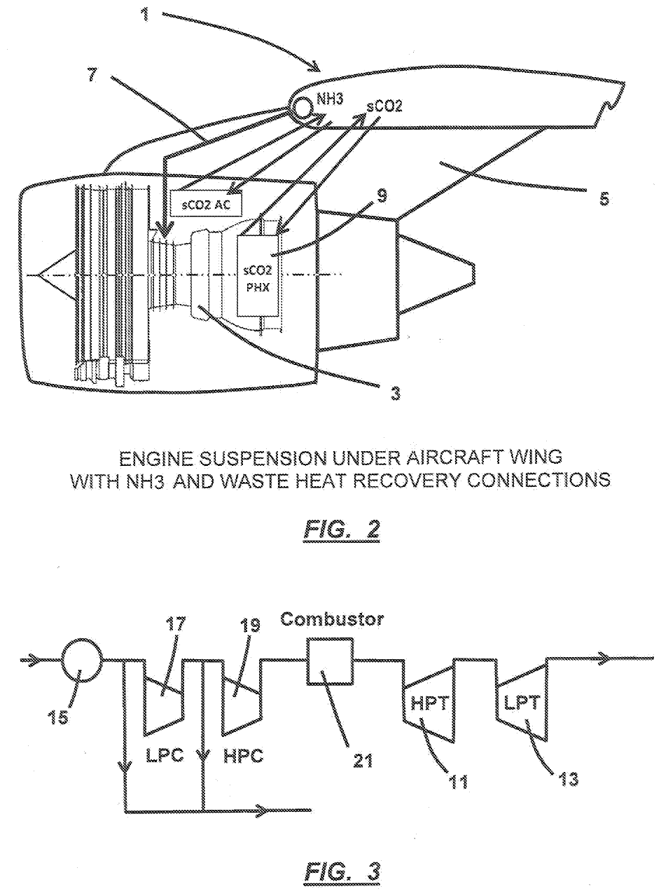

In one embodiment, the engine may be the engine of an aircraft. FIG. 2 shows an aircraft employing a system of the invention. The aircraft includes a wing or fuselage 1 supporting an engine 3 secured to the wing on pylon 5. The wing 1 contains a storage tank storing ammonia (NH₃) in liquid form that is supplied via a conduit 7 to the engine 3. To maintain the ammonia in liquid form at all environmental temperatures of the aircraft, which may go up to as much as 40 degrees C., the storage tank is configured to maintain the ammonia therein at pressures of 15 to 16 atm, and preferably up to at least 20 atm.

Hence, a system as depicted in FIG. 2 may augment overall airplane performance by the use of a supercritical carbon dioxide (sCO2) power cycle to convert core exhaust heat into electricity for onboard uses. The sCO2 power subsystem aids in the recovery of waste heat in the wake of the engine, which can aid in addressing ammonia's low gravimetric energy density. The wing structure also preferably houses the supercritical CO₂ (sCO2) system that communicates with an sCO2 primary heat exchanger 9 that extracts heat from the exhaust gases of the engine 3 and converts them to AC electrical power for use in aircraft systems.

The system may be used for any aircraft, but it is believed that a particularly desirable airframe for application of the system is a narrowbody aircraft. Narrowbody passenger aircraft account for a larger proportion of CO₂ emissions in aviation than wide-body aircraft, and market forecasts through 2040 show that narrowbody aircraft deliveries are projected to outpace widebody by a factor of 4.25.

A suitable aircraft for the application of the system is a Boeing 737-8 (737 MAX 8). A Boeing 737-8 seats up to 220 passengers (typically 178-193 in a two-class cabin) and has a rated range of 3,550 nautical miles. The Boeing 737-8 accounts for nearly 50% of 737 MAX sales. It is powered by the CFM LEAP-1B high-bypass ratio turbofan engine, or possibly by its predecessor design engine, the CFM56-5B2 engine.

A schematic of one of these engines is shown in FIG. 3. The engine is a high bypass ratio turbofan engine (most of the air bypasses the core of the engine and is exhausted out of the fan nozzle) with a bypass ratio of 5.2:1, generating 27,236 N (6,123 lbf) of thrust at 10,668 m (35,000 ft) and Mach number 0.74. The engine is a two-shaft (or two-spool) engine, where each shaft is powered by its own turbine section (the high-pressure turbine 11 and the low-pressure turbine 13, respectively). The fan 15 and booster (commonly called the low-pressure compressor, LPC 17) are mounted on the low-pressure shaft. The overall pressure ratio is 35.496 and the fan pressure ratio is 1.7. The maximum cycle temperature is 1,619 degrees K. The LPC increases the pressure of air received through the front intake and fan 15 of the engine. The high-pressure compressor (HPC) 19 and the high-pressure turbine 11 are mounted on a high-pressure shaft, and the HPC receives the air pressurized by the LPC and increases its pressure further to a high pressure for transmission to the combustor unit 21 of the engine. The combustor unit 21 receives the high-pressure air from HPC 19 and also fuel, and combustion takes place that drives the HPT 11 and LPT 13. Exhaust gas leaves the engine on the right side of the diagram.

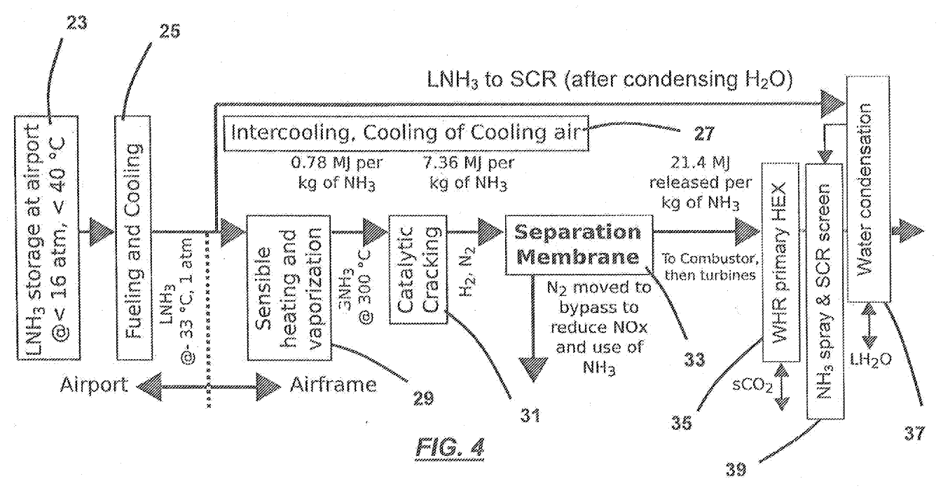

Referring to FIG. 4, in a system according to the invention, liquid ammonia (LNH₃) is stored as fuel at an airport in a storage container or tank 23 that maintains its liquid state by keeping the liquid ammonia at a pressure up to about 16 atm and at a temperature of less than 40 degrees C. For purposes of handling the liquid it may be cooled to −33 degrees C. so that it remains liquid at 1 atm, and supplied into the aircraft fuel tank at that temperature or by a high-pressure connection in a fueling and cooling step 25.

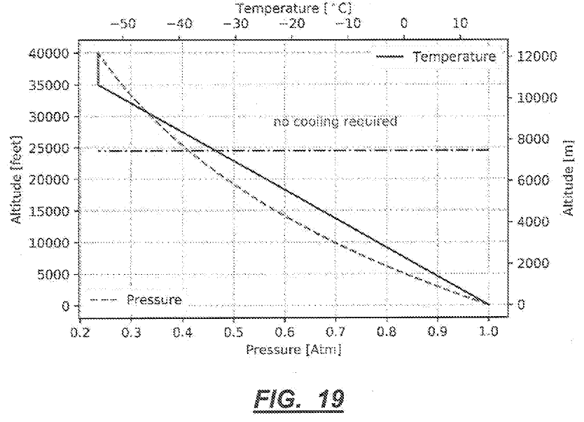

The ammonia is stored in the storage tank of the airframe as LNH₃. One major advantage of ammonia over hydrogen is the higher temperature at which it goes into the liquid phase at standard atmospheric pressure, which is −33° C. (240K) compared to hydrogen at −252.9° C. (20K), respectively. Consequently, the cooling and insulation requirement is reduced, which results in less weight and reduced cooling power during flight. In-cruise cryo-cooling for ammonia is not required as it remains in a liquid state above 25,000 feet altitude due to the low ambient temperature in the atmosphere with increasing height, as shown in the graph of FIG. 19. At ground level, where the temperature may be as high as 40 degrees C., the airframe ammonia fuel tank is reinforced structurally to contain LNH₃ as a liquid at 16 atm pressure.

Ammonia does not coke like kerosene. As a result, stored liquid ammonia on the aircraft can be used for various thermal management duties, such as compressor intercooling, cooling of cooled cooling air (CCA), and cooling of aviation electronics, which significantly improves core efficiency and specific fuel consumption (SFC) and/or minimizes extraction of power and compressed air from the core for non-propulsion purposes. These thermal management tasks could not be accomplished with kerosene (or with e-ethanol or e-methanol) because of its coking or thermal degradation, nor could they be accomplished easily with hydrogen because of its leakage and flammability potential. In fact, improved core efficiency as noted here can partially negate the lower gravimetric energy density of ammonia.

The LNH₃ is initially used for intercooling the air compressed by the LPC 17 before the HPC 19 at step 27. The use of NH₃ for intercooling between the LPC 17 and HPC 19 significantly reduces the power consumed by the HPC 19, thus improving overall core efficiency. This improvement can be significant, increasing the core efficiency from a typical value of ˜40% to more than ˜50%. A low level of continuous intercooling can also be added by cooling the stationary casing, with an additional reduction in compressor work.

A significant fraction (˜20% or higher) of air is extracted from the compressor as TCLA (total cooling and leakage air). If the extracted air is first cooled using NH₃, as indicated in FIG. 3, step 27, then the overall cooling potential is increased, leading to a lower coolant mass flow rate and higher core efficiency. This cooled cooling air (CCA) can be implemented in the system of the invention because NH₃ is an endothermic fuel that does not coke and is not as prone to leakage and explosion hazards as H₂. These increases in core efficiency significantly offset increased weight due to the lower energy density of NH₃.

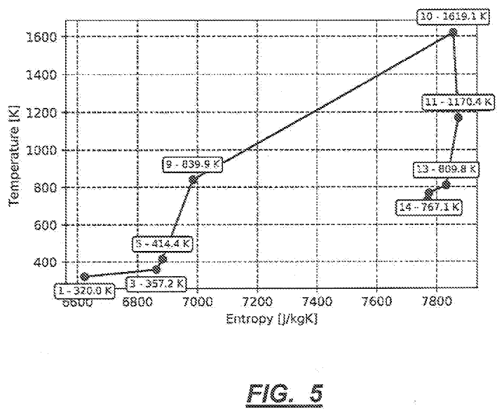

Another potential emission from the engine is water vapor from H₂ combustion, which potentially leads to contrail formation. However, H₂ combustion does not create soot particles that could act as nucleation sites for condensation/ice-formation, so contrails are reduced. In addition, the NH₃ needed for selective catalytic reduction (SCR) can be routed, while still in a liquid state at approximately −33° C., through a heat exchanger (FIGS. 3 and 5) to condense water out of the exhaust stream from the engine, thus reducing water vapor partial pressure and minimizing contrail formation.

The primary purpose of the NH₃, however, is to provide H₂ gas to the engine as fuel. The initial step of that process is that the LNH₃ is heated by the heat exchanger (step 29) to derive heat in the air introduced by the LPC 17, raising the temperature of the LNH₃ to a higher temperature, such as, for example, 300 degrees C., and this temperature elevation also converts the LNH₃ to gaseous NH₃. The heating of the LNH₃ to this temperature requires approximately 0.78 MJ for each kilogram of NH₃.

Once the NH₃ is gaseous, it is transmitted to a catalytic cracking module in step 31. The catalytic cracking module receives heat from the HPC or the engine of approximately 7.36 MJ per kg of NH₃, and with that input energy cracks the NH₃, causing it to dissociate into H₂ and N₂, which are output as a mixture of those gases, plus some NH₃ that is not disassociated as less than 10% of the output mixture.

According to the embodiment shown, the output mixture is then separated by a separation membrane into two gas streams, one of which is essentially pure H₂ gas that can pass through the membrane, and the other which is a mixture of primarily N₂ with undisassociated NH₃ and a residual amount of H₂ that did not pass through the separation membrane. The H₂ is sent to the combustor and burned, releasing 21.4 MJ per kg of NH₃, and driving the turbines, and creating thrust. The other gas mixture is carried to a point upstream of the LPC and there mixed with the air that is passing through and being compressed in the LPC and the HPC, in some part bypassing the combustion part of the process to reduce NOₓ and use of NH₃.

Alternatively, instead of separating the H₂ and the other mixed gases from cracking, to reduce NOₓ and to control the combustion of the H₂, the mixture of gases output from the cracking module may be supplied, without any separation, directly to the combustor of the engine as a fuel mixture. This reduces the temperature of the combustion and its energy output, which is very high for the combustion of H₂ compared with hydrocarbon fuels.

After combustion, the exhaust is combusted gas products at high temperature, and a waste heat recovery system (WHR) 35 extracts heat from the exhaust gases using supercritical CO₂ as a working fluid, and converts that heat to electrical energy for use in the other aircraft systems. In addition, the heated exhaust gases are cooled (step 37), as described previously, using the LNH₃ as coolant, and, in a step 39, some NH₃ is sprayed into the exhaust gas stream that subsequently flows through a selective catalytic reduction (SCR) screen that causes a reaction with the exhaust gas that removes NOₓ from the exhaust.

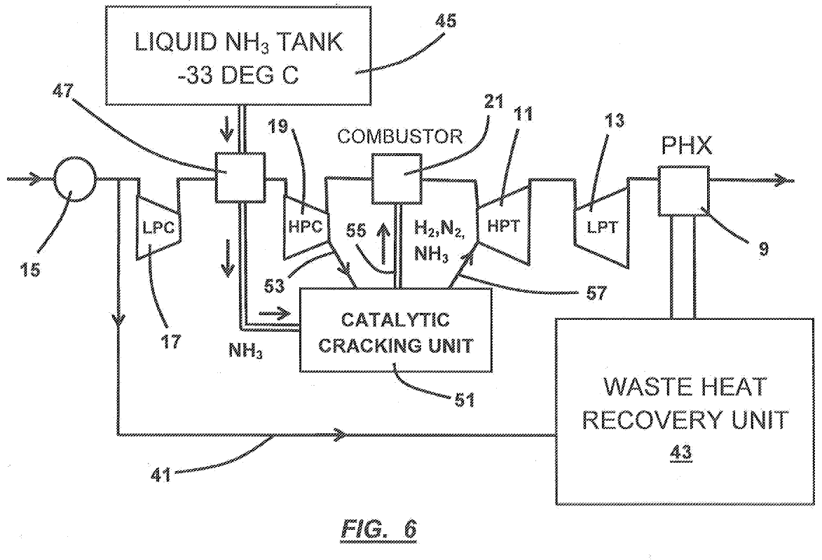

FIG. 6 shows the repurposing of a current aircraft engine and the addition of components to adapt the engine, particularly a high-bypass ratio turbofan engine, such as for example the CFM LEAP-1B or the CFM56-5B2 engine, to operate as set out in FIG. 4.

The fan 15 and LPC 17 have a bypass conduit 41 between them. The bypass line 41 is the air that bypasses the core as it is extracted after the fan. The bypass air's purpose is to provide a heat sink for the waste heat recovery unit (WHR unit) 43. The heat for the unit is transferred through the primary heat exchanger (PHX) 9, which is located after the LPT 13 so as to contact the engine exhaust gas. The WHR unit 43 is a sCO2 fluid system that has the capability to generate electric power that can support the APUs (in cruise mode of the aircraft) or can replace engine-mounted generators.

In addition, the aircraft is provided with liquid NH₃ tank 45, which at altitude is allowed to cool to the ambient temperature to below −33 degrees C., maintaining the NH₃ in its liquid state without pressurization, but which also maintains pressure of at least 16 atm to preserve the liquid state where ambient temperatures rise to as much as 40 degrees C. A heat exchanger or intercooler 47 is provided that uses the LNH₃ to cool air output from the LPC 17. The cooled air flows on to the HPC 19, while the heat evaporates the LNH₃ to form gaseous NH₃ (GNH₃) that flows though conduit 49 to catalytic cracking unit 51.

Catalytic cracking unit 51 also receives heated air from the HPC 19 through conduit 53. An exchange of heat occurs in the cracking unit, as the catalytic cracking of GNH₃ to H₂ is endothermic. The endothermic cracking reaction is a heat sink that cools the air from the HPC 19 for cooling the HPT 11, thereby also enabling better turbine blade cooling performance. The heated air heats the operative portions of the catalytic cracking unit, which cracks the NH₃ so as to generate H₂ and N₂. The catalytic cracking unit then separates the H₂ and supplies that and some or all of the output gases from the cracking process to combustor 21 via conduit 55, where combustion takes place, driving the turbines, i.e., HPT 11 and LPT 13. In addition, the now-cooled air from the HPC 19 is transmitted via conduit 57 to cool the high pressure turbine HPT 11.

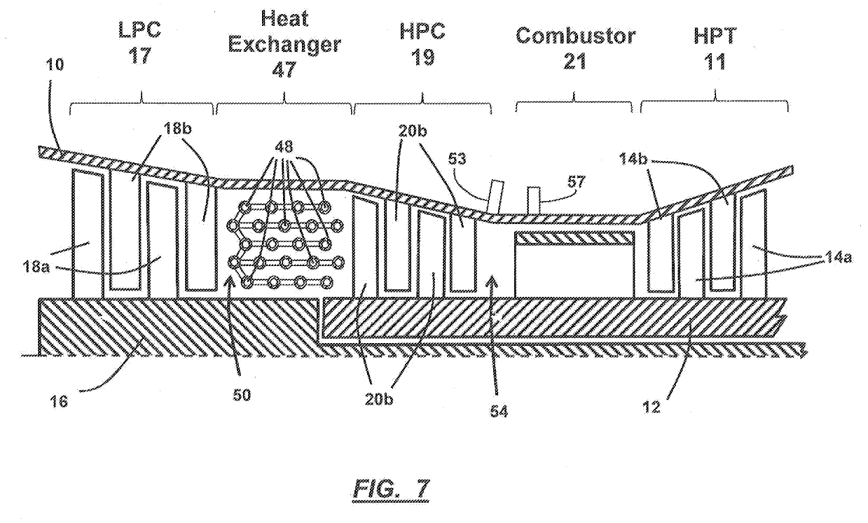

FIG. 7 shows the internal structure of an engine according to an embodiment of the invention as illustrated in FIG. 6. LPC 17 is formed of a central rotatable turbine shaft 16 supporting fixedly blades 18a for rotation relative to vanes 18b supported stationary on the outer shroud 10 fixedly supported on the stationary airframe. The blades 18a and vanes 18b cooperate as the turbine shaft 16 is rotated so as to compress air from the intake and compel it rearward, increasing its pressure and making it flow over tubes or microtubes 48 in heat exchanger 47.

Tubes 48 are connected in parallel to a supply line from the LNH₃ tank that supplies liquid NH₃ to flow through them. The tubes 48 extend circumferentially around the turbine shaft 16 in the annular space 50 defined between it and the outer shroud 10, and are supported in a baffle or other support structure in the air flow. The tubes 48 carry the LNH₃ through them so as to cool the air flowing through space 50, and they are configured to maximize the surface-to-volume ratio of the tubes 48 to optimize heat exchange with the air from the LPC.

The heat imparted to the LNH₃ causes it to become gaseous NH₃, and the tubes 48 of the heat exchanger 47 all combine to connect to supply the gaseous NH₃ to conduit 52 (FIG. 6), which supplies the gaseous NH₃ to the catalytic cracking unit 51. The temperature of the gaseous NH₃ is preferably at least 300 degrees K, which is the minimum temperature for effective cracking of the NH₃ into H₂ and N₂.

After being cooled by the heat exchanger 47, the air flows rearward to HPC 19, which comprises blades 20a mounted on rotatable second turbine shaft 12, and vanes 20b mounted on stationary shroud 10. Blades 20a and vanes 20b co-act to impart more pressure to air flowing through HPC 19, which also heats the air to about 500 degrees K.

The air from the HPC flows to plenum 54 where it is divided into a first stream of about 75% or more of the pressurized air from HPC 19, which is directed to the combustor 21 and used to burn the H₂ fuel derived from cracking. The remaining 25% or less of the air bypasses the combustor and is at least partially routed through conduit 53 to the cracking unit 51 (FIG. 6) where the heat of the air is used to crack the gaseous NH₃. That endothermic process absorbs heat and cools the air flow from conduit 53, and the cooled air is returned via conduit 57, where it is mixed with any bypass air flow from the HPC 19 that was not supplied to the cracking unit 51 in the area of the combustor 21 so as to flow to the HPT, which has turbine vanes 14b that are cooled by that cooled air.

Operative parameters for the exemplary aircraft engine, the CFM56-5B2 engine, provided with the ammonia-based fuel system of the invention are set out in Table 2.

TABLE 2
ENGINE PERFORMANCE PARAMETERS-CASES 1 TO 6

| | | | | (3) & (4) | (3) & (4) | | |
|---|---|---|---|---|---|---|---|
| | (1) | (1) | (1) | Take-Off & | Take-Off & | (2) | |
| Operation mode | Ground | Ground | Ground | Landing | Landing | Cruise | — |
| Case | 1 | 2 | 3 | 4 | 5 | 6 | — |
| Altitude | 0 | 0 | 0 | 1,668 | 9,668 | 10,668 | m |
| | 0 | 0 | 0 | 5,472.44 | 31,719.2 | 35,000 | ft |
| Ambient temperature | 320 | 310 | 288.1 | 277.31 | 225.31 | 218.81 | K |
| Mach Number | 0 | 0 | 0 | 0.3 | 0.5 | 0.74 | — |
| Fuel flow | 1.1 | 1.13 | 1.21 | 1.04 | 0.48 | 0.47 | kg/s |
| SFC | 10.24e−6 | 10.11e−6 | 9.89e−6 | 13.65e−6 | 15.04e−6 | 17.32e−6 | kg/s(fuel)/N |

Point 13

| | | | | | | | |
|---|---|---|---|---|---|---|---|
| T13 | 826.3 | 808.6 | 773.43 | 740.74 | 670.34 | 635.71 | K |
| P13 | 135.6 | 137.64 | 143.16 | 114.6 | 44.41 | 36.52 | kPa |
| Mass flow rate | 59.25 | 61.69 | 67.77 | 59.95 | 28.56 | 28.4 | kg/s |

Point 3

| | | | | | | | |
|---|---|---|---|---|---|---|---|
| T3 | 364.52 | 354.48 | 332.82 | 320.39 | 268.89 | 258.98 | K |
| P3 | 154.2 | 156.1 | 160.67 | 131.34 | 47.9 | 40.35 | kPa |
| Mass flow rate | 389.95 | 403.14 | 434.84 | 389.26 | 175.19 | 177 | kg/s |

Point 5

| | | | | | | | |
|---|---|---|---|---|---|---|---|
| T5 | 422.87 | 412.91 | 391.52 | 378.89 | 325.69 | 313.11 | K |
| P5 | 247.63 | 253.98 | 269.08 | 223.72 | 86.62 | 72.64 | kPa |
| Mass flow rate | 59.33 | 61.78 | 67.91 | 60.11 | 28.65 | 28.49 | kg/s |

Point 9

| | | | | | | | |
|---|---|---|---|---|---|---|---|
| T9 | 856.98 | 840.73 | 806.97 | 779.03 | 697.6 | 661.32 | K |
| P9 | 2,663.49 | 2,751.10 | 2,974.54 | 2,448.84 | 1,020.90 | 834.16 | kPa |
| Mass flow rate | 48.43 | 50.44 | 55.45 | 49.07 | 23.39 | 23.26 | kg/s |

The engine operates in four different modes, namely (1) ground, (2) cruise, (3) landing, and (4) take-off, which have various fuel operating parameters and the various stages of a flight mission. Six cases are shown from the operational modes. Mode (1), ground, is split into three cases 1 to 3 corresponding to varying temperatures at the ground simulating summer and winter conditions. Cases 4 and 5 are for landing mode (3) and take-off mode (4), and, finally, case 6 is for cruise mode (2).

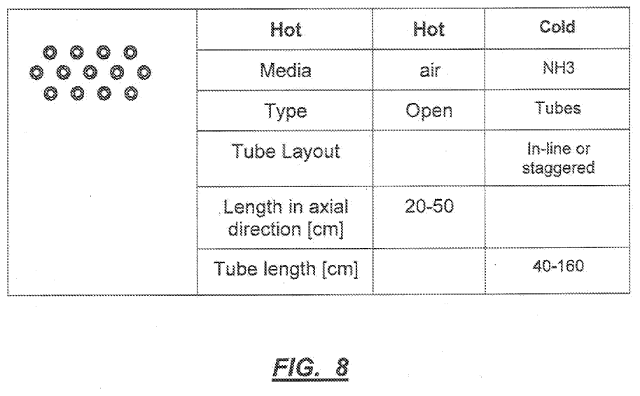

Referring to FIG. 8, the heat exchanger 47 and its operative parameters are shown. The heat exchanger is installed in the annular volume downstream of the Low-Pressure Compressor (LPC) stage 17 of the engine to acquire heat for evaporating the liquid ammonia fuel. Other heat exchangers in the system diagram of FIG. 6, including those contained within the Waste Heat Recovery Unit 47, are described in L. Vesely et al., “sCO2 Waste Heat Recovery System for Aircraft Engines,” AIAA Scitech 2022 Forum, which is herein incorporated by reference.

The heat exchanger has a core flow rate that may be varied to achieve a target NH₃ outlet temperature. Limiting the core flow in this manner enables the heat exchanger to achieve a very low air-side pressure drop (ΔP/P<0.5%). A variable flow rate can be achieved in practice using a thermostatically controlled inlet ramp for the core flow entering the heat exchanger. Operating conditions for the heat exchanger are set out in Table 3.

TABLE 3
HEAT EXCHANGER OPERATING CONDITIONS

| Case | | 1 | 2 | 3 | 4 | 5 | 6 |
|---|---|---|---|---|---|---|---|
| Altitude [km] | | 0 | 0 | 0 | 1.7 | 9.7 | 10.7 |
| Mach [-] | | 0 | 0 | 0 | 0.3 | 0.5 | 0.74 |
| Core Flow (Air) | Inlet P | 247.6 | 254 | 269.1 | 223.7 | 86.6 | 72.6 |
| | [kPa] | | | | | | |
| | Inlet T [K] | 422.9 | 412.9 | 391.5 | 378.9 | 325.7 | 313.1 |
| | Max Flow | 59.3 | 61.2 | 67.9 | 60.1 | 28.7 | 28.5 |
| | [kg/s] | | | | | | |
| Fuel Flow (NH₃) | Inlet P | 101.3 | 101.3 | 101.3 | 101.3 | 101.3 | 101.3 |
| | [kPa] | | | | | | |
| | Inlet T [K] | 240.2 | 240.2 | 240.2 | 240.2 | 240.2 | 240.2 |
| | Flow [kg/s] | 1.1 | 1.13 | 1.2 | 1.04 | 0.48 | 0.47 |

In another embodiment, the heat exchanger 47 may be an intercooler in the form of an annular plate-fin heat exchanger in a cross-flow arrangement. LPC discharge temperatures are typically less than 450 degrees K, which enables the use of a 6000 series aluminum alloy in the intercooler. The intercooler structure has offset-strip fins that provide heat transfer enhancement for the hot (engine core) and cold (NH₃) flow paths.

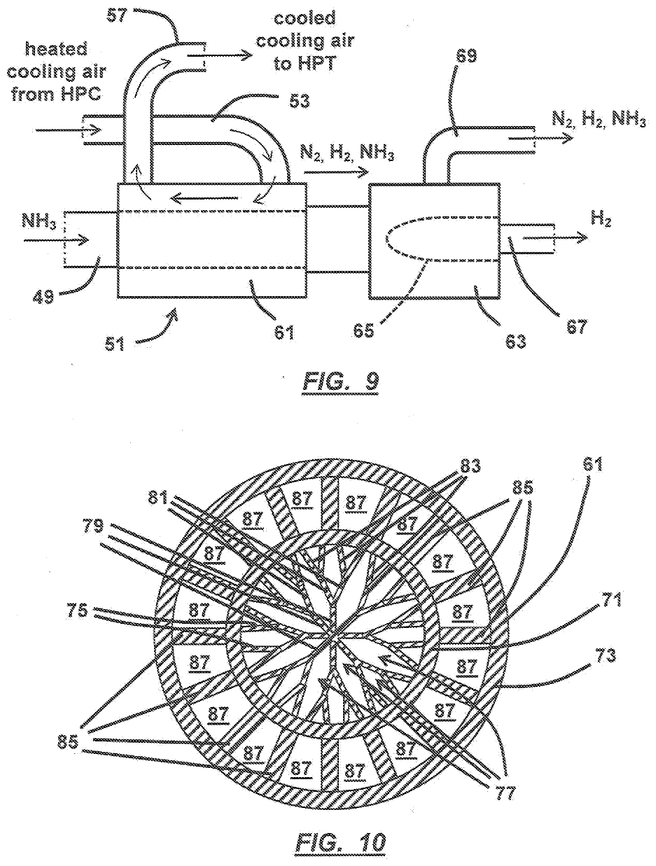

As best shown in FIG. 9, the catalytic cracking unit 51 is composed of a cracking module 61 and a separation membrane unit 63. Cracking unit 51 is supported adjacent the engine and is connected with conduit 49, which carries gaseous NH₃ to it that is derived from heating the liquid NH₃ from the NH₃ storage in the wing using heat from a heat exchanger cooling the air of the LPC to make the liquid NH₃ become gaseous NH₃. In addition, the HPC heats the air when it compresses it, and is cooled by air. That air is heated in the process and conduit 53 carries the heated air from the HPC to the cracking unit. That heated air circulates in the cracking unit 61

The catalytic cracking unit 61 has in it passageways with a surface that is coated with a catalyst that promotes the cracking from ammonia to hydrogen. This is an endothermic process, meaning that heat is adsorbed, and the heat is provided by heated air supplied via conduit 53 from the HPC 19 so that the surfaces are heated to about 300 degrees C. The passage through which the air flows has a surface topology that is configured to optimize, or at least facilitate to at least some degree, heat transfer from the air flow to the body of the cracking unit, and therein to the catalyst surfaces in the module over which the NH₃ flows and has contact. That heat provides the energy required for the endothermic cracking process, and the result is that the catalytic cracking unit 61 outputs a gas mixture of H₂ and N₂, together, in this embodiment, with a relatively low amount of NH₃, preferably less that 10% or less than 5% that is not cracked because the cracking process is not 100% efficient.

In addition, the air from the HPC loses heat and is cooled during its passage through the cracking unit 61, and leaves through conduit 57 to go to cool the high-pressure turbine. The first turbine stage experiences extreme temperatures after combustion and is actively cooled by bleed air from the compressor. Typically, though, the HPC compressor exit temperature of the compressed cooling air is high. Cold cooling air improves the turbine performance and hence the core efficiency of the engine, and the cooled cooling air is cooled by exchanging heat with cracking process. In summary, the system provides a heat sink for improved turbine cooling by providing the required endothermic task of ammonia cracking.

A variety of catalysts may be used to effectuate the cracking process in the various cracking apparatus described herein. The most commonly used catalyst for cracking ammonia is iron and nickel, ruthenium, or boron nitride.

The Haber-Bosch process uses an iron-based catalyst to produce ammonia from nitrogen. This reaction is reversible, and the catalyst mass composition must be tailored to improve ammonia yields. Poor iron-based Haber-Bosch catalysts allow the realization of the reverse reaction. Previous work in this area has shown that high surface area iron particles supported on a silicate matrix have good hydrogen yields from ammonia. See W. C. Tucker, “Strong catalytic activity of iron nanoparticles on the surfaces of reduced olivine,” Icarus, 299, pp. 502-512 (2018).

The surface area and the support for the iron greatly affect the efficiency of this process. It was shown that the common mineral olivine (Mg2+, Fe2+)2SiO₄ could be reduced to produce 10-50 nm diameter iron nanoparticles on a forsterite (Mg2SiO₄) surface. This composition displayed strong catalytic activity not seen in powders without Fe nanoparticles with a rapid decomposition of NH₃ to hydrogen and nitrogen observed. The energetics of catalytic decomposition of ammonia into hydrogen is comprehensively described in I. Dincer, Comprehensive energy systems, Elsevier (2018).

The gas mixture of H₂, N₂, and NH₃, produced by the catalytic cracking unit 61 flows to the separation membrane unit 63 where it meets a separation membrane 65. Preferably, this membrane is composed of palladium coated vanadium. That membrane material is permeable to hydrogen but not to nitrogen, hence enabling the separation, and H₂ passes through the membrane and out of the separation membrane unit through H₂ conduit 67. The N₂ and NH₃, as well as a small amount of H₂, do not pass through the membrane 65, and the gas mixture of those components flows to a different outlet conduit 69.

Generally, as ammonia is cracked into hydrogen and nitrogen, both gases have to be separated, with nitrogen being ejected to the atmosphere and hydrogen being routed to the combustion system via conduit 67. The NH₃, N₂, and H₂ gas mixture separated from most of the H₂ may be transferred via conduit 69 harmlessly to the bypass flow, with the NH₃, N₂, and H₂ gas mixture being mixed with the compressed air passing through the LPC and HPC, which reduces the weight penalty of carrying extra NH₃ would be needed for Selective Catalytic Reduction (SCR) if ammonia were not the fuel source for the aircraft.

Alternatively, the NH₃, N₂, and H₂ gas mixture may be supplied with the compressed air from the LPC and HPC to the combustion chamber, as the inclusion of at least a portion of these gases may be beneficial in terms of addressing NOₓ issues, because the presence of ammonia in the combustion reduces the temperature of the combustion and reduces the production of NOₓ.

As another alternative, it may be desirable, in order to reduce NOₓ and also to reduce the very exothermic nature of the H₂ combustion in the engine, that the separation unit be removed, and that the output of the cracking unit be a mixture of H₂, N₂ and a substantial amount of NH₃ that is transmitted to the combustor of the engine to be combusted together. The presence of the NH₃ reduces the NOₓ, and the presence of NH₃ and N₂ in the combustor reduces the temperature of the combustion of the H₂, which may be beneficial to the engine components or to the operation of the engine. For those purposes, H₂ is present in the gaseous mixture in a range of 30% to 70% by volume, and NH₃ is present in a range of 30% to 70% by volume.

Thermal NOx considerations are important at high temperatures in the presence of ambient nitrogen, but when NH₃ is used as a fuel or hydrogen carrier, the fuel-bound nitrogen can lead to fuel NOx. For this reason, the cracking of NH₃ is ideal to make H₂ available for combustion, while the highly stable N₂ byproduct will inhibit the NOx formation. Standard practice for NOx control in power plants is to use NH₃ for selective catalytic reduction (SCR) to reform NOx back to harmless N₂ and O₂, with a dramatic reduction of NOₓ to ˜3 ppm. Thus, the onboard NH₃ can be used to nearly eliminate the NOx emissions, which would not be possible with other fuels.

Referring to FIG. 10, a possible configuration for the catalytic cracking unit 61 is shown in cross section. The cracking unit 61 has an inner cylinder 71 and an outer cylinder 73. The inner cylinder 71 has an interior space in which vanes 75 extend creating a number of passageways 77. The vanes 75 are planar and extend substantially over the length of the unit 61. The innermost vanes 79 extend radially outwardly from a center longitudinal axis of the inner cylinder a distance less than the radius of the cylinder 71, and then branch into two or more further vanes 81, which may each split into still more outward vanes 83. All of the passageways between the vanes communicate with the NH₃ inlet conduit 49 at one end of the unit 61, and with the outlet at the opposite end of the unit 61. The surfaces of all of the vanes are covered with the catalyst material, e.g., iron or another appropriate catalyst so there is a large catalyst surface area provided made up of all of the surfaces of all of the vanes.

The outer cylinder and the inner cylinder 71 define between them an annular volume in which planar heat transfer walls 85 extend radially between the cylinders 71, 73, dividing the annular volume up into passages 87 extending the length of the unit 61, all of which communicate with air conduits 53 and 57 so that heated air from conduit 53 flows into all of the passages, heats the walls 85 and inner cylinder 71, and then flows out of the unit through outlet conduit 57. The configuration is intended to facilitate heat transfer from the air flow, through the inner cylinder wall 71 and to the catalyst surfaces, so as to provide heat for the endothermic ammonia cracking process.

The system of the invention operates using heat derived from its operation to crack the ammonia to derive hydrogen to fuel its operation. Accordingly, to start the engine, battery power is used to heat the catalytic cracking unit to the point that it can generate hydrogen fuel or to drive the HPC so that it produces heated cooling air that heats the catalytic cracking unit to operational temperature, and to also turn the rotor shaft of the engine. The hydrogen when generated is then combusted, starting fuel driven operation of the engine.

It should be noted that the NH₃ can be pumped in the liquid phase, and not as a gas, to minimize pumping power requirements, in order to provide the pressure head necessary for all operations.

The foregoing embodiment uses heat derived from the operation of the engine, and in particular from the LPC and HPC compressors of the engine, both of which heat the air as they compress it. Specifically, in the foregoing embodiment, the heat from the LPC is used to convert the liquid NH₃ to gaseous NH₃, and the heat from the HPC is used to provide the endothermic energy that cracks the NH₃ into H₂ and N₂ in the cracking module.

In addition to the heat from the compressors, however, heat from the operation of the engine also includes combustion of the fuel in the combustor 21, and heat from that part of the operation of the engine may be also used for cracking the ammonia.

FIG. 11 schematically illustrates an alternate embodiment of combustor with a cracking unit that is integrated into the combustor cylinder liner. Ammonia storage tank 45 supplies liquid ammonia that is preferably heated, as described above, by heat from a heat exchanger cooling the LPC to become gaseous NH₃. The gaseous NH₃ is supplied via a conduit 91 to a manifold or splitting structure indicated at 93. Manifold 93 divides the flow of gaseous NH₃ and distributes it to a plurality of smaller conduit tubes 95 connected in parallel in the liner or cylinder wall that connect to channels 97 in the combustor liner of combustor 21.

The combustion liner is a crucial part of the combustion system. It contains the flame and is exposed to some of the highest temperatures within gas turbine system, and the combustion liner is actively cooled using compressor bleed air. The combustor liner itself may be made from a high-temperature alloy such as Inconel, and it may be coated with a ceramic thermal barrier coating, or the liner may be fully ceramic. It can be conventionally machined or additively manufactured.

The tubes 97 extend through or adjacent the liner of combustor 21 and absorb heat from the combustion. The absorbed heat provides the energy that causes cracking of the NH₃ into N₂ and H₂ in the tubes 97, yielding a gas mixture of H₂, N₂, and some uncracked NH₃ in each of the tubes 97. The cracking products from the tubes 97 are combined by a combining structure 99 that mixes the gas output from all of the tubes 95 in a common outlet conduit as a mixture containing N₂, H₂, and, if cracking is not complete, NH₃, that flows out to a conduit 101. Conduit 101 carries the products of the cracking process to a separation unit 63 (FIG. 9), or directly to the combustor 21 for combustion, as was set out above for the earlier embodiment.

The channels 97 are coated internally with a catalyst to act as cracking-promoting surfaces while cooling the combustion liner. For the catalyst, most commonly used are iron and nickel, ruthenium, or boron nitride. The catalyst may be applied to the surface or in the channel together with a catalyst support to allow for gas flow. The channels 97 may be additively manufactured, and may have turbulence-promoting features such as ribs, pins, or other engineered surface roughnesses inside them to improve the cracking process. For example, the channels 97 may have one or more properties of the following: straight, wavy, triply-periodic-minimal surfaces (TPMS), staggered, and may have other internal features that increase surface area and promote turbulence.

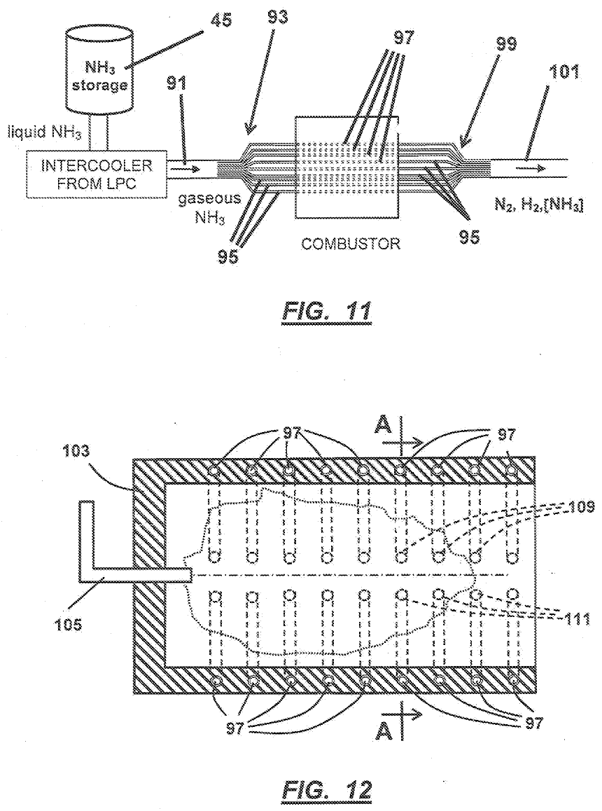

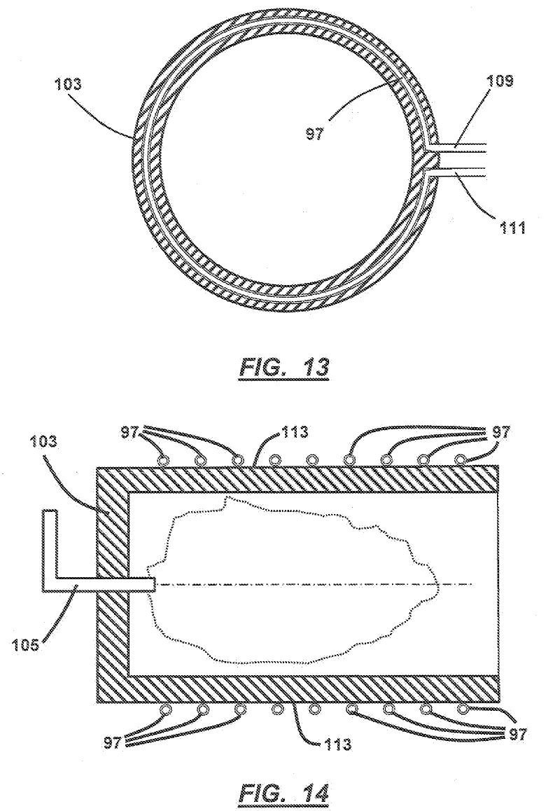

FIGS. 12 and 13 show one variant of the arrangement of the channels 97 in the combustion liner 103. The H₂ fuel, and any mixed gases, is fed to the combustion chamber by supply line 105, and combustion takes place therein, yielding a flame generally indicated at 107. The metal or ceramic combustor liner 103 has cracking and cooling tubes 97 therein that are internally coated with catalyst. Ammonia (NH₃) or another hydrogen (H₂) carrier enters the channels 97 so as to flow around the circumferential path of the channels, and is cracked by heat provided from the combustor. In addition to cracking the NH₃, this heat acquisition is a heat sink that cools the combustor and reduces its cooling requirements.

As best shown in FIG. 13, the channels 97 are all circumferential within the cylindrical structure of the combustor liner 103. Each of the axially spaced channels 97 has a respective inlet conduit 109 connecting with the manifold 93, and a respective outlet conduit 111 connecting with the combiner structure 99.

In the embodiment shown, each channel 97 extends almost completely around 360 degrees of circumference of the cylindrical liner 103. Depending on acquired heat appropriate for a given engine or application, however, the circumferential tubes may go around the cylinder of the liner one quarter of the circumference (i.e., arranged as four separate channels of 90 degrees of the circumference distributed around the circumference), a third of the circumference (i.e., three separate channels of 120 degrees of the circumference distributed around the circumference), or one or two complete circumferences (360 degrees or 720 degrees).

Referring to FIG. 14, the circumferential channels 97 may alternatively be supported on a radially outward surface 113 of the liner 103 so as to receive heat from the combustion and use it for cracking. The channels 97 are configured the same as in the above embodiment, and are lined with catalyst material and connect with manifold 93 and combiner 95 as above. They also may extend a full revolution around the cylindrical combustion chamber, or each extend over a portion of the circumference, as with the above embodiment.

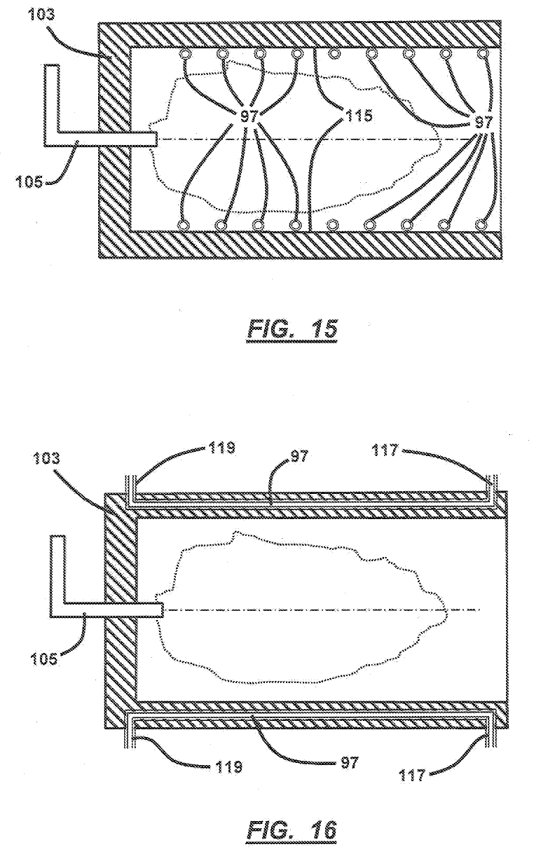

FIG. 15 shows another variant of the placement of channel tubes 97, in which the channel tubes 97 are secured on a radially inward surface 115 of the combustor liner 103. The channel tunes 97 are similarly configured to those of FIG. 15 and extend around the interior cylindrical space of the liner 103 about 360 degrees or a lesser portion of the circumference. Each of the loops of the channel tubes 97 has an inlet leading ammonia from the manifold 93 and an outlet to the combiner 99 that extend through the wall of the liner from the interior of the combustor chamber.

FIG. 16 shows another alternate arrangement of channel tubes 97 that extend in-line, axially, in the combustor. The axial tubes each has a respective inlet 117 connected with the manifold 93 that carries the NH₃ into the channel to be cracked therein. Each channel tube 97 extends axially inside the liner 103, where it is heated by the ongoing combustion so as to crack the NH₃, and at an opposite end connects with a respective outlet 19, through which the cracked gaseous products exit and flow to the combiner 99.

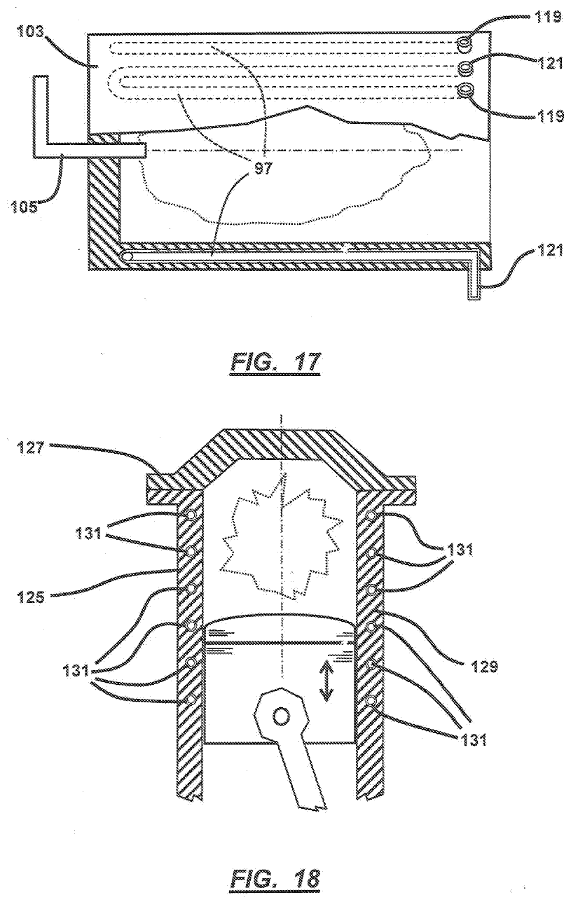

FIG. 17 shows another variant of the axial channels in which the channels 97 have a U-shaped path that extends from an inlet 119 down the liner 103, turns around 180 degrees, and extends back through or along the liner so as to exit at outlet 121 adjacent where it entered. Inlets 119 are connected with manifold 93 and receive NH₃ therefrom, and outlets 121 are connected with combiner 99, and supply the products of cracking there. The channels are lined with catalyst as described above and crack the NH₃ over the length of the U-shaped pathway.

There are a variety of configurations of combustion chambers, and embodiments of these cracking channels may be used in can, can-annular, or annular style combustion chambers of a gas turbine engine.

Furthermore, the apparatus and methods of using ammonia as a source of fuel described herein can be applied to gas turbines in general, independent of their use. The engines can include engines for aircraft, as described above, but also engines used for marine vessels, engines for land vehicles, e.g., railroad locomotives, or engines for stationary power generation, or for any other application for which hydrogen fuel combustion may be considered desirable, or for which provision of fuel using NH₃ is desirable. Engines that may be used advantageously in the invention herein include the engines sold under the trade names LM 6000, LM 2500, and LM 2500XPRESS by the GE Gas Power division of General Electric.

In addition to application to turbine engines, the apparatus and methods can also be used in an internal combustion engine burning hydrogen derived from ammonia.

In that context, an internal combustion engine may not have initial compressors such as the LPC or HPC found in the turbine engines described above. The heat to be used for cracking the ammonia to yield the H₂ fuel gas is best derived from the heat of combustion in the cylinder of the reciprocating piston engine.

Referring to FIG. 18, a cylinder of a reciprocating piston engine is shown, comprising a cylinder wall 125 with a cylinder head 127. A piston 129 is supported in the cylinder wall 125 for reciprocating movement responsive to combustion on the cylinder 125.

The cylinder wall 125 is provided with catalyst-lined channels 131 surrounding the interior of the cylinder, with an arrangement in the cylinder wall the same as or similar to the channels shown in the combustion liner in FIGS. 12 and 13, i.e., extending circumferentially with the channels are embedded in the cylindrical wall. As with the embodiment of FIGS. 12 and 13, each loop of the channels 131 has a respective inlet connecting with a source of NH₃, such as manifold 93 of FIG. 11, and a respective outlet transmitting the products of cracking in the channel 131.

The channels in the cylinder wall may alternatively be of the configurations of FIG. 14, 16, or 17, where the channels are circumferential tubes affixed to an outer surface of the cylinder wall 125 (see FIG. 14), or as tubes embedded in the cylinder wall and extending axially (FIG. 16) or in an axial U-shaped path (FIG. 17). In all of the configurations, heat from the combustion in the cylinder cracks the ammonia in the channels in the cylinder wall 125, as in the process described above, yielding H₂ used as fuel for the internal combustion engine.

The terms used herein should be viewed as terms of description rather than limitation, as those of ordinary skill in the art with this disclosure before them will be able to make changes and modifications thereto without departing from the spirit of the invention.

What is claimed is:

1. A power system for a vehicle, comprising:
a storage tank containing ammonia;
an engine supported on the vehicle, said engine being configured to operate using hydrogen gas as fuel;
a conversion device receiving ammonia from the storage tank and heat from the engine, said conversion device using the heat from the engine to dissociate said ammonia so as to produce hydrogen gas; and
said conversion device supplying the hydrogen gas to the engine wherein combustion of said hydrogen gas takes place, producing energy that drives said engine so as to move the vehicle.

2. The power system of claim 1, wherein the conversion device is a cracking apparatus having passages containing a catalyst effective for cracking the ammonia in an endothermic cracking process to form the hydrogen gas, wherein said passages receive the ammonia therein and allow the ammonia to pass therethrough so that the ammonia dissociates in the passages at least partially into the hydrogen gas and nitrogen gas.

3. The power system of claim 2, wherein the engine is a turbine engine having a first turbine driving a first compressor, said first compressor compressing air that is provided to a combustor chamber of the turbine engine wherein combustion of the hydrogen gas proceeds; and
wherein heat created by the first compressor compressing the air is supplied to the cracking apparatus as heat causing dissociation of the ammonia into the hydrogen gas and the ammonia.

4. The power system of claim 2, wherein the turbine engine has
a second compressor compressing the air before compression by the first compressor, and
a heat exchanger cooling air compressed by the second compressor;
the storage tank storing the ammonia in a liquid form;
wherein heat from the heat exchanger is applied to change the liquid ammonia to gaseous ammonia, said gaseous ammonia being supplied to the cracking apparatus after which the ammonia is dissociated into hydrogen gas and nitrogen.

5. The power system of claim 4, wherein the turbine engine has a second turbine driving the second compressor.

6. The power system of claim 4, wherein the cracking apparatus outputs a gas mixture containing the hydrogen gas, nitrogen, and some of the ammonia supplied thereto.

7. The power system of claim 6, and further comprising a separating apparatus that receives the gas mixture and separates the gas mixture into
a first gaseous product that is mostly the hydrogen gas, and that is supplied to the engine to be combusted, and
a second gaseous product that contains hydrogen, nitrogen and ammonia gas.

8. The power system of claim 7, wherein the second gaseous product is supplied to the second compressor wherein the second gaseous product is mixed with air being drawn into the engine and supplied to the combustor.

9. The power system of claim 6, wherein the gas mixture is supplied to the combustor chamber, and the gas mixture supplied to the combustor chamber contains
30% to 70% by volume of hydrogen gas; and
30% to 70% by volume of ammonia.

10. The power system of claim 6, wherein the vehicle is an aircraft and the engine has an exhaust area through which products of the combustion are expelled, said exhaust area having a heat exchanger extracting heat from the exhaust, and the aircraft has a supercritical CO₂ (sCO2) system receiving the extracted heat and converting said heat to electrical current supplied to the aircraft.

11. The power system of claim 3, wherein first compressor is cooled by air flowing thereto from the cracking apparatus so as to produce heated air that is returned to the cracking apparatus as heat used for cracking the ammonia.

12. The power system of claim 11, wherein the cracking device includes
a cylindrical module having an interior space divided into passages by web each having catalyst material thereon and through which the ammonia flows and is cracked; and
an outer volume surrounding the interior space and separated therefrom through which the heated air from the first compressor flows and is cooled by transmission of heat thereof to the passages of the interior space; and
a conduit carrying the air from the outer volume back to the first turbine so as to cool the first turbine.

13. The power system of claim 6, wherein the vehicle is an aircraft and the engine has an exhaust area through which products of the combustion are expelled, the exhaust area including a catalyst screen and spray device spraying ammonia into the exhaust so as to reduce NOₓ in the products of the combustion.

14. The power system of claim 1, wherein the vehicle is marine vessel or a train locomotive.

15. The power system of claim 1, wherein the vehicle is an aircraft, and the storage tank storing the ammonia stores the ammonia in a liquid form and is configured to maintain the ammonia in said liquid form at all environmental temperatures of the aircraft, the storage tank being configured to maintain the ammonia therein at a pressures of at least 15 atm, and preferably at least 20 atm.

16. The power system of claim 1, wherein the heat supplied to the conversion device is produced by the combustion of the hydrogen gas.

17. A method of using ammonia for providing hydrogen fuel for an engine of an aircraft, said method comprising:
supplying liquid ammonia to a tank on said aircraft and storing the liquid ammonia therein;
converting said liquid ammonia to gaseous ammonia using heat from the engine;
using heat from the engine to crack the gaseous ammonia by an endothermic cracking process in a catalytic cracking component so as to dissociate the ammonia into hydrogen gas and a gas containing nitrogen; and
burning the hydrogen gas in the engine of the aircraft so as to drive the engine and provide thrust to the aircraft.

18. The method of claim 17, and further comprising
driving a compressor that compresses air received from outside the aircraft so as to increase a temperature thereof;
cooling the compressed air from the compressor by heat exchange with the catalytic cracking component that provides the heat as energy that drives the cracking step.

19. The method of claim 18, wherein the compressor comprises a low pressure compressor and a high pressure compressor; and
wherein the low pressure compressor heats air from outside the aircraft so as to heat it, and
wherein the converting the liquid ammonia to gaseous ammonia includes cooling the air compressed by the low pressure compressor with the liquid ammonia such that the liquid ammonia becomes gaseous.

20. The method of claim 19, wherein the heat from the engine used to crack the ammonia is derived from cooling the high pressure compressor.

21. The method of claim 19, wherein the catalytic cracking component outputs a gas mixture containing hydrogen gas, nitrogen gas, and ammonia, and the method includes
separating the gas mixture into a hydrogen gas fraction and a second gas mixture containing, nitrogen gas, hydrogen gas and ammonia;
supplying the hydrogen gas fraction to the engine to be burned therein; and
supplying the second gas mixture to the low pressure compressor so as to be combined with air compressed thereby and transmitted to a combustion chamber of the engine.

22. The method of claim 18, wherein the catalytic cracking component outputs a gas mixture containing hydrogen gas, nitrogen gas, and ammonia gas, said gas mixture containing 30% to 70% by volume of hydrogen gas and 30% to 70% by volume of ammonia gas; and
the method includes supplying the gas mixture to a combustion chamber of the engine, said burning including burning the gas mixture in the combustion chamber.

23. An aircraft fueled using ammonia, said aircraft comprising:
a wing having therein a storage tank storing NH₃ in liquid form, said tank being constructed to support an internal pressure of the liquid NH₃ up to at least 20 atm;
an engine supported on or adjacent the wing and connected with the tank by a conduit transmitting the liquid NH₃ thereto;
the engine being a turbine engine configured to burn hydrogen as a fuel, and comprising
a low-pressure compressor receiving air from outside the aircraft,
a heat exchanger operatively associated with the low-pressure compressor so as to cool the compressed air output therefrom,
the heat exchanger receiving liquid NH₃ from the tank and using said liquid NH₃ to cool the compressed air output by the low-pressure compressor so that the liquid NH₃ becomes gaseous NH₃,
a high-pressure compressor connected so as to receive the cooled compressed air output by the low-pressure compressor and the heat exchanger, compressing the cooled compressed air so as to increase the pressure thereof,
an air-cooling device cooling the air output by the high-pressure compressor;
a cracking unit receiving the gaseous NH₃ from the heat exchanger and also receiving heated air from the high-pressure compressor via the air-cooling device, said cracking device using the heat from the heated air from the high-pressure compressor in an endothermic cracking process that cracks the gaseous NH₃ into H₂ and N₂ and outputs a gas mixture of H₂, N₂ and NH₃,
a combustor receiving the cooled compressed air from the high-pressure compressor and the gas mixture or a gas derived therefrom, and providing combustion of the gas mixture therein so as to produce heat and exhaust gases;
a high-pressure turbine adjacent the combustor and driven by the combustion, said high-pressure turbine driving the high-pressure compressor;
a low-pressure turbine adjacent the high-pressure turbine and also driven by the combustion, said low-pressure turbine driving the low-pressure compressor; and
an exhaust portion of the engine through which the exhaust gases leave the engine.

24. The aircraft of claim 23, wherein said gas mixture output by the cracking unit includes H₂ in a concentration of 30-70% by volume and NH₃ in a concentration of 30-70% by volume, and the gas mixture is conveyed to the combustor and burned therein.

25. The aircraft of claim 23, wherein the aircraft further comprises
a separating unit having a selectively permeable membrane therein permitting passage of H₂ gas but blocking passage of N₂ and NH₃, said separating unit dividing the gas mixture output by the cracking unit into a hydrogen fraction comprising at least 90% H₂ by volume, and a remnant gas fraction that contains a remainder of the gases in the gas mixture;
wherein the hydrogen fraction is conveyed to the combustor and burned therein, and the remnant gas fraction is transmitted to the low-pressure compressor and mixed with air intaken therethrough.

26. The power system according to claim 1, wherein the engine has a combustion chamber with an interior space in which the combustion of the hydrogen gas takes place, and the conversion device uses heat from the combustor chamber of the engine to dissociate said ammonia so as to produce the hydrogen gas.

27. The power system according to claim 26, wherein the combustion chamber includes a liner wall surrounding the interior space, and
wherein the conversion device includes a plurality of tubes supported on or in the liner wall, said tubes each having an interior surface defining an interior passage, the interior surface having thereon a catalyst configured to aid in cracking of ammonia to yield hydrogen, each of the tubes receiving gaseous ammonia at a first end thereof, cracking the ammonia in the interior passage with heat from the combustion in the combustion chamber so as to produce a gas product mix containing the hydrogen gas, and outputting the gas product mix at an opposite second end thereof.

28. The power system according to claim 27, wherein a manifold connects the first ends of the tubes with a line supplying the gaseous ammonia, said gaseous ammonia being derived from stored liquid ammonia exposed to heat from a low pressure compressor in a heat exchanger apparatus in the engine.

29. The power system according to claim 27, wherein the tubes each extend in a respective pathway on or in the combustor liner between the ends thereof, said pathway being partly or completely circumferential about a circumference of the combustor liner or axially of the combustor liner.

30. The power system according to claim 29, wherein the tubes are embedded with a wall of the combustor liner.

31. The power system according to claim 29, wherein the tubes are secured on an inner surface of the combustor liner facing inward toward a flame of the combustion.

32. The power system according to claim 29, wherein the tubes are secured on an outer surface of the combustor liner facing outward away from a flame of the combustion.

33. The power system according to claim 2, wherein the engine includes a combustor in which the combustion of the hydrogen gas takes place, said combustor including a generally cylindrical combustor liner having a cylindrical wall of ceramic material;
the cracking apparatus including
a manifold connected with a conduit and receiving therefrom gaseous ammonia derived from the liquid ammonia in the storage tank by heating the liquid ammonia;
a plurality of channels connected in parallel to the manifold and all receiving gaseous ammonia therefrom;
the channels each extending in a respective path in the wall of the combustor liner;
the paths each being U-shaped and first extending axially along the combustor liner, turning 180 degrees and extending back axially along the combustor liner to a respective outlet;
the channels being surfaced interiorly with catalyst material conducive to cracking ammonia to hydrogen and nitrogen gas, and being heated by heat from the combustion such that an endothermic cracking process cracks the gaseous ammonia flowing through the channels so as to yield a gas mix containing hydrogen, nitrogen, and some of the gaseous ammonia;
the outlets of the channels connecting with a combiner structure that combines the gas mix from all the channels in a common conduit;
the common conduit transmitting the gas mix to the combustor to be burned therein, or transmitting the gas mix first to a separator that separates a hydrogen fraction of the hydrogen gas from the gas mix, and then supplies the hydrogen fraction to the combustor to be burner therein.
